(19) United States
(12) Patent Application Publication
(10) Pub. No.: US 2021/0407218 A1
(43) Pub. Date: Dec. 30, 2021

(54) PARKING MANAGEMENT SYSTEM, PARKING MANAGEMENT DEVICE, AND COMPUTER-READABLE RECORDING MEDIUM

(71) Applicant: TOYOTA JIDOSHA KABUSHIKI KAISHA, Toyota-shi (JP)

(72) Inventor: Sei KATO, Kawasaki-shi (JP)

(73) Assignee: TOYOTA JIDOSHA KABUSHIKI KAISHA, Toyota-shi (JP)

(21) Appl. No.: 17/335,609

(22) Filed: Jun. 1, 2021

(30) Foreign Application Priority Data
Jun. 30, 2020 (JP) 2020-113144

(51) Int. Cl. G07B 15/04; G06Q 30/02; G06Q 20/32; G06Q 10/02; G08G 1/017; G06K 9/00

(52) U.S. Cl. CPC G07B 15/04; G06Q 30/0284; G06Q 20/3223; G06K 2209/23; G08G 1/017; G06K 9/00785; G06K 2209/15; G06Q 10/02

(57) ABSTRACT

A parking management system includes: a management server including a first processor that includes hardware; and a parking server including a second processor that includes hardware. The first processor is configured to acquire information of a vehicle that has entered a parking area from the parking server, identify the vehicle that has entered the parking area and a user boarding the vehicle based on the information of the vehicle, and connect the information of the vehicle and the payment information of the user and output the information of the vehicle and the payment information of the user to the parking server. The second processor is configured to calculate a parking fee of the vehicle based on parking time of the vehicle, a payment amount included in the payment information, and a parking fee agreement that is preset, and open an exit gate provided in the parking area.

### CROSS-REFERENCE TO RELATED APPLICATION(S)

The present application claims priority to and incorporates by reference the entire contents of Japanese Patent Application No. 2020-113144 filed in Japan on Jun. 30, 2020.

### BACKGROUND

### 1. Technical Field

The present disclosure relates to a parking management system, a parking management device, and a computer-readable recording medium.

### 2. Related Art

In JP 2015-184780 A, a parking usage system which manages entry/exit of vehicles at a parking area by using parking tickets is disclosed.

A technique that enables smooth entry/exit of vehicles at the parking area has been desired.

### SUMMARY

In some embodiments, a parking management system includes: a management server including a first processor that includes hardware; and a parking server including a second processor that includes hardware. The first processor is configured to acquire information of a vehicle that has entered a parking area from the parking server, identify the vehicle that has entered the parking area and a user boarding the vehicle based on the information of the vehicle, and if payment information of the user is acquired from a terminal of the user, connect the information of the vehicle and the payment information of the user and output the information of the vehicle and the payment information of the user to the parking server. The second processor is configured to calculate a parking fee of the vehicle based on parking time of the vehicle, a payment amount included in the payment information, and a parking fee agreement that is preset, and if payment of the parking fee has been completed by the terminal, open an exit gate provided in the parking area.

In some embodiments, a parking management system includes: a management server including a first processor that includes hardware. The first processor is configured to acquire information of a vehicle that has entered a parking area from the parking server provided at the parking area, identify the vehicle that has entered the parking area and a user boarding the vehicle based on the information of the vehicle, if payment information of the user is acquired from a terminal of the user, connect the information of the vehicle and the payment information of the user, and calculate a parking fee of the vehicle based on parking time of the vehicle, a payment amount included in the payment information, and a parking fee agreement that is preset, and if payment of the parking fee has been completed by the terminal, open an exit gate provided in the parking area.

In some embodiments, a parking management device includes: a processor including hardware. The processor is configured to acquire information of a vehicle that has entered a parking area from the parking server provided at the parking area, identify the vehicle that has entered the parking area and a user boarding the vehicle based on the information of the vehicle, and if payment information of the user is acquired from a terminal of the user, connect the information of the vehicle and the payment information of the user and output the information of the vehicle and the payment information of the user to the parking server to calculate a parking fee of the vehicle based on parking time of the vehicle, a payment amount included in the payment information, and a parking fee agreement that is preset.

In some embodiments, a parking management device includes: a processor comprising hardware. The processor is configured to acquire information of a vehicle that has entered a parking area from the parking server provided at the parking area, identify the vehicle that has entered the parking area and a user boarding the vehicle based on the information of the vehicle, if payment information of the user is acquired from a terminal owned by the user, connect the information of the vehicle and the payment information of the user, and calculate a parking fee of the vehicle based on parking time of the vehicle, a payment amount included in the payment information, and a parking fee agreement that is preset.

In some embodiments, provided is a non-transitory computer-readable recording medium with an executable program stored thereon. The program is a parking management program configured to cause a processor including hardware to execute: acquiring information of a vehicle that has entered a parking area from the parking server provided at the parking area; identifying the vehicle that has entered the parking area and a user boarding the vehicle based on the information of the vehicle; and if payment information of the user is acquired from a terminal of the user, connecting the information of the vehicle and the payment information of the user and outputting the information of the vehicle and the payment information of the user to the parking server to calculate a parking fee of the vehicle based on parking time of the vehicle, a payment amount included in the payment information, and a parking fee agreement that is preset.

In some embodiments, provided is a non-transitory computer-readable recording medium with an executable program stored thereon. The program is a parking management program configured to cause a processor having hardware to execute: acquiring information of a vehicle that has entered a parking area from the parking server provided at the parking area; identifying the vehicle that has entered the parking area and a user boarding the vehicle based on the information of the vehicle; if payment information of the user is acquired from a terminal of the user, connecting the information of the vehicle and the payment information of the user, and calculating a parking fee of the vehicle based on parking time of the vehicle, a payment amount included in the payment information, and a parking fee agreement that is preset.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram schematically illustrating a configuration of a parking management system according to an embodiment;

FIG. 2 is a block diagram illustrating details of constituent elements of the parking management system according to the embodiment;

FIG. 3 is a flow chart illustrating an example of a flow of a parking management method according to a first embodiment;

FIG. 4 is a flow chart illustrating an example of the flow of the parking management method according to a modification example of the first embodiment; and

FIG. 5 is a flow chart illustrating an example of the flow of the parking management method according to a second embodiment.

### DETAILED DESCRIPTION

A parking management system, a parking management device, and a parking management program according to an embodiment of the present disclosure will be described with reference to drawings. Note that the constituent elements in the embodiment described below include those which are replaceable for those skilled in the art or include practically the same ones.

Parking Management System

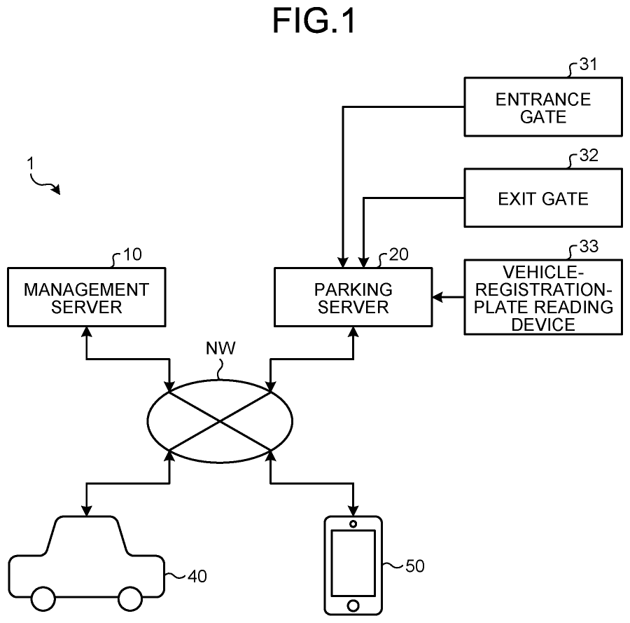

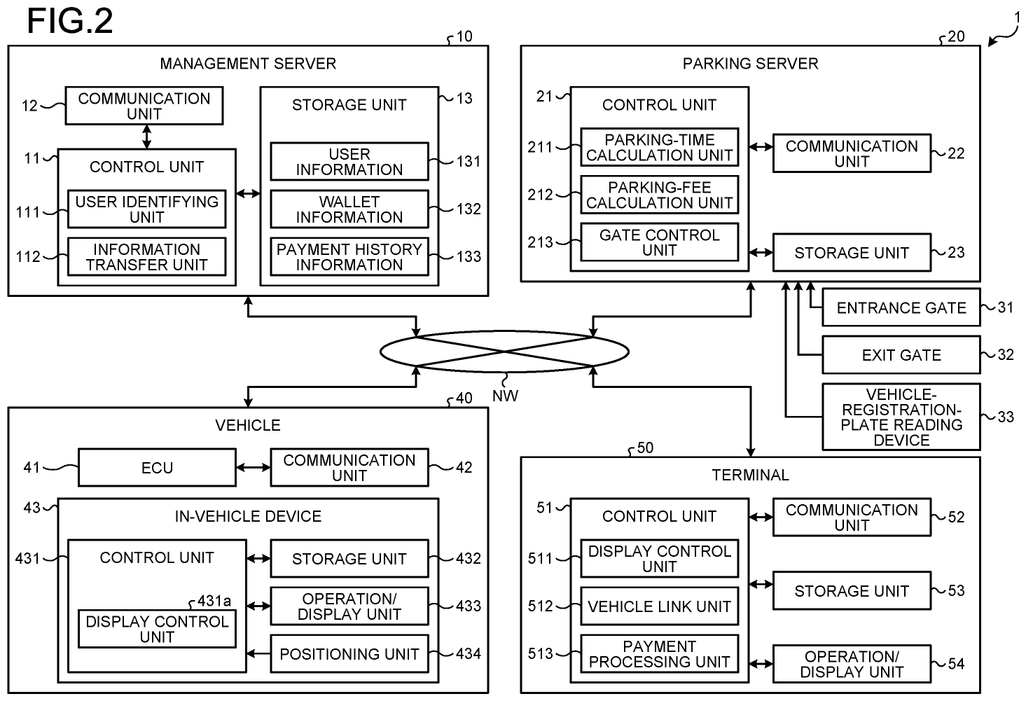

A configuration of a parking management system according to an embodiment will be described with reference to FIG. 1 and FIG. 2. The parking management system is for making automatic payment of a parking fee which is coupled, for example, with payment of a user at a shop affiliated with parking (hereinafter, referred to as “affiliated shop”) when the user parks a vehicle in the parking. Note that the “affiliated shop” refers to a shop which owns/manages the parking. Also, note that the “parking” refers to a parking area.

As illustrated in FIG. 1, the parking management system 1 includes a management server 10, a parking server 20, a vehicle 40, and a terminal 50. The parking management device according to the embodiment is realized specifically by a function of the management server 10. All of the management server 10, the parking server 20, the vehicle 40, and the terminal 50 are provided with a communication function and are configured to be mutually communicable via a network NW. This network NW includes, for example, an Internet network, a mobile phone network, and/or the like.

An entrance gate 31 is provided at an entrance of the parking. This entrance gate 31 detects arrival of the vehicle 40 at the entrance gate 31, for example, by a sensor or the like and outputs entry time of the vehicle 40 to the parking server 20. Also, an exit gate 32 is provided at an exit of the parking. This exit gate 32 detects arrival of the vehicle 40 at the exit gate 32, for example, by a sensor or the like and outputs exit time of the vehicle 40 to the parking server 20.

Also, a vehicle-registration-plate reading device 33 is provided near the entrance gate 31. This vehicle-registration-plate reading device 33 includes, for example, a camera and an image recognition device. When the vehicle 40 arrives at the entrance gate 31, the vehicle-registration-plate reading device 33 recognizes a vehicle number of the vehicle 40 by capturing an image of a vehicle registration plate of the vehicle 40 and carrying out image processing of the captured image. Then, the vehicle-registration-plate reading device 33 outputs the recognized vehicle number to the management server 10. The vehicle 40, which has entered the parking, can be quickly and precisely identified by reading the vehicle number by the vehicle-registration-plate reading device 33 in this manner.

The vehicle 40 and the terminal 50 is provided with a communication function such as Wireless Fidelity (registered trademark, WiFi), Bluetooth (registered trademark) Low Energy (BLE), or the like. Then, when the user who owns the terminal 50 boards the vehicle 40, the terminal 50 and the vehicle 40 are connected by the communication functions thereof, and the terminal 50 and the vehicle 40 are associated with each other.

Management Server

The management server 10 is a server for managing a wallet service provided to users and is managed by an administrator of the wallet service. The management server 10 provides a parking-fee payment service of the parking as part of the wallet service. The management server 10 is realized, for example, by a workstation or a general-purpose computer such as a personal computer. As illustrated in FIG. 2, the management server 10 is provided with a control unit (first processor) 11, a communication unit 12, and a storage unit 13.

The control unit 11 is specifically provided with a processor including, for example, a Central Processing Unit (CPU), a Digital Signal Processor (DSP), or a Field-Programmable Gate Array (FPGA) and a memory (main storage unit) including, for example, a Random Access Memory (RAM) or a Read Only Memory (ROM).

The control unit 11 loads a program, which is stored in the storage unit 13, into a work area of the main storage unit, executes the program, and control constituent units, etc. through execution of the program, thereby realizing functions matching predetermined objects. Through the execution of the program, the control unit 11 functions as a user identifying unit 111 and an information transfer unit 112.

The user identifying unit 111 identifies the vehicle 40, which has entered the parking, and the user(s) boarding the vehicle 40. Herein, the “user” in the embodiment refers to an occupant (driver or passenger) of the vehicle 40 who is a user of the wallet service (person who signed up for the service).

The user identifying unit 111 first acquires information of the user boarding the vehicle 40 (hereinafter, referred to as “occupant information”) from the vehicle 40. This “occupant information” includes information for identifying the vehicle 40 (for example, a vehicle number or the like) and information for identifying the user (for example, a user ID or the like of the wallet service).

Also, the user identifying unit 111 acquires information of the vehicle 40 which has entered the parking (hereinafter, referred to as “vehicle information”) from the parking server 20. This vehicle information specifically refers to the vehicle number of the vehicle 40, which has been read by the vehicle-registration-plate reading device 33. Then, the user identifying unit 111 collates the occupant information acquired from the vehicle 40 with the vehicle information acquired from the parking server 20, thereby identifying the vehicle 40, which has entered the parking, and the user boarding the vehicle 40.

The user identifying unit 111 may identify the user without acquiring the occupant information from the vehicle 40. In such a case, the management server 10 previously acquires the vehicle number of the vehicle 40 and the occupant information of the vehicle 40 and stores the vehicle number and the occupant information as user information 131 in the storage unit 13. Then, when the vehicle information is acquired from the parking server 20, the user identifying unit 111 collates the occupant information of the vehicle 40, which has been previously retained, with the vehicle information acquired from the parking server 20, thereby identifying the vehicle 40, which has entered the parking, and the user boarding the vehicle 40.

The information transfer unit 112 transfers payment information, which has been acquired from the terminal 50, to the parking server 20. This “payment information” is the information about the payment made by the user at the affiliated shop and includes, for example, the name of the shop where the payment has been made, payment time, payment amount, etc. Note that, since the user who owns the terminal 50 may be either one of the driver and the passenger of the vehicle 40, the payment information also includes two types, i.e., the payment information about the payment made by the driver and the payment information about the payment made by the passenger. When the payment information of the user is acquired from the terminal 50, the information transfer unit 112 connects the vehicle number included in the vehicle information, which has been previously acquired from the parking server 20, with the payment information and outputs the vehicle number and the payment information to the parking server 20.

Also, if an additional parking fee is required, in other words, if information about an additional parking fee (hereinafter, “additional fee information”) has been acquired from a parking-fee calculation unit 212 when the vehicle 40 exits the parking, the information transfer unit 112 outputs the additional fee information to the terminal 50.

The communication unit 12 includes, for example, a Local Area Network (LAN) interface board, a wireless communication circuit for wireless communication, etc. The communication unit 12 is connected to the network NW such as the Internet, which is a public telecommunication network. The communication unit 12 carries out communication with the parking server 20, the vehicle 40, and the terminal 50 by the connection with the network NW.

The storage unit 13 includes a recording medium such as an Erasable Programmable ROM (EPROM), a hard disk drive (Hard Disk Drive: HDD), and a removable medium. Examples of the removable media include disk recording media such as Universal Serial Bus (USB) memories, Compact Discs (CDs), Digital Versatile Discs (DVDs), and Blu-ray (registered trademark) Discs (BDs). The storage unit 13 can store an operating system (Operating System: OS), various programs, various tables, various databases, etc.

The storage unit 13 stores the user information 131, wallet information 132, and payment history information 133 of each user of the wallet service. Also, in the storage unit 13, for example, the occupant information acquired from the vehicle 40, the vehicle information acquired from the parking server 20, the additional fee information, etc. is stored in accordance with needs.

The user information 131 is information about the user who uses the wallet service. The user information 131 includes, for example, a user ID of the user who has previously registered for usage of the wallet service, a password, a name of the user, contact of the user (for example, address, phone number, mail address, etc.), etc.

The wallet information 132 is information about an electronic wallet (hereinafter, “wallet”) of the wallet service. The wallet refers to a virtual account for deposits and withdrawals of electronic money. The wallet information 132 includes, for example, a user ID, the balance of electronic money, a charge history of electronic money, a usage history of electronic money, etc.

The payment history information 133 is information about payment of the wallet service. The payment history information 133 includes the user ID, a payment means used for payment (for example, electronic money payment (non-contact payment), payment by scanning, payment by code, etc.), a purchase history of commercial products, or the like.

Parking Server

The parking server 20 is a server for managing the parking and is managed by a manager of the parking. The parking server 20 is realized, for example, by a workstation or a general-purpose computer such as a personal computer.

As illustrated in FIG. 2, the parking server 20 is provided with a control unit (second processor) 21, a communication unit 22, and a storage unit 23. Specific configurations of the control unit 21, the communication unit 22, and the storage unit 23 are similar to those of the control unit 11, the communication unit 12, and the storage unit 13 of the management server 10. The control unit 21 functions as a parking-time calculation unit 211, a parking-fee calculation unit 212, and a gate control unit 213 through execution of a program stored in the storage unit 23.

The parking-time calculation unit 211 calculates parking time of the vehicle 40 based on the entry time of the vehicle 40, which has been acquired from the entrance gate 31, and the exit time of the vehicle 40, which has been acquired from the exit gate 32.

The parking-time calculation unit 211 may present, to the terminal 50 side, how much longer the vehicle 40 can be parked for free, for example, while the user parks the vehicle 40 in the parking and shops at the affiliated shop. In this case, the parking-time calculation unit 211 calculates the remaining time that allows free parking for the vehicle 40 based on the entry time of the vehicle 40 and an agreement on the parking fee, which has been preset, and outputs the information about the remaining time to the terminal 50. In response to this, a display control unit 511 of the terminal 50 causes an operation/display unit 54 to display the information about the remaining time. Since the remaining time that allows free parking in the parking is presented to the user in this manner, the user can do shopping, etc. without worry.

Note that the “agreement on the parking fee” is, for example, an agreement on the parking fee per hour, the free usage time of the parking corresponding to a payment amount (shopping amount) at the affiliated shop of the parking, or the like, and examples thereof includes information such as “free for one hour after the vehicle is parked, and 200 yen per 30 minutes thereafter”. The information about the agreement on the parking fee is, for example, previously stored in the storage unit 13.

The parking-fee calculation unit 212 calculates the parking fee of the vehicle 40 based on the parking time of the vehicle 40 calculated by the parking-time calculation unit 211, the payment amount included in the payment information of the terminal 50 acquired from the management server 10, and the agreement on the parking fee.

Herein, if the parking fee calculated by the parking-fee calculation unit 212 is 0 yen, in other words, if the parking fee is cancelled out by the payment amount, the parking-fee calculation unit 212 outputs the information indicating this fact to the parking server 20. In response to this, the gate control unit 213 opens the exit gate 32 and permits exit of the vehicle 40 from the parking.

Also, if the parking fee calculated by the parking-fee calculation unit 212 is not 0 yen, in other words, if the parking fee is not cancelled out by the payment amount, the parking-fee calculation unit 212 outputs the additional fee information to the management server 10.

The parking-fee calculation unit 212 may present, to the terminal 50 side, that how much more shopping makes the parking fee free, for example, while the user parks the vehicle 40 in the parking and is doing shopping at the affiliated shop. In such a case, the parking-fee calculation unit 212 calculates the remaining amount of the payment amount required to make the parking fee free based on the parking time obtained by subtracting the entry time of the vehicle 40 from the current time, the payment amount included in the payment information of the user acquired from the management server 10, and the agreement on the parking fee and outputs the information about the remaining amount to the terminal 50. In response to this, the display control unit 511 of the terminal 50 causes the operation/display unit 54 to display the information about the remaining amount. When the shopping amount which makes the parking fee free is presented to the user in this manner, the buying motivation of the user can be enhanced, and the sales of the affiliated shop can be increased.

The gate control unit 213 controls opening/closing of the entrance gate 31 and the exit gate 32. If arrival of the vehicle 40 at the entrance gate 31 is detected by the entrance gate 31, the gate control unit 213 opens the entrance gate 31 and permits entry to the parking. Also, if arrival of the vehicle 40 at the exit gate 32 is detected by the exit gate 32 and if any of the following is satisfied, the gate control unit 213 opens the exit gate 32 and permits exit from the parking.

(1) if the parking fee calculated by the parking-fee calculation unit 212 is 0 yen

(2) if checkout of the parking fee has been completed

Herein, “if checkout of the parking fee has been completed” includes, for example, a case in which the parking fee calculated by the parking-fee calculation unit 212 is not 0 yen (the parking fee is not cancelled out by the payment amount), wherein an additional parking fee is required, but checkout of the parking fee has been completed by the terminal 50.

Vehicle

The vehicle 40 is a mobile object capable of communicating with outside. As illustrated in FIG. 2, the vehicle 40 is provided with an Electronic Control Unit (ECU) 41, a communication unit 42, and an in-vehicle device 43. The ECU 41 integrally controls working of various constituent elements mounted on the vehicle 40. The communication unit 42 includes, for example, a Data Communication Module (DCM) or the like and carries out communication with the management server 10, the parking server 20, and the terminal 50 by wireless communication via the network NW.

The in-vehicle device 43 is provided with a control unit 431, a storage unit 432, an operation/display unit 433, and a positioning unit 434. Specific configurations of the control unit 431 and the storage unit 432 are similar to those of the control unit 11 and the storage unit 13 of the management server 10. The control unit 431 functions as a display control unit 431a through execution of a program stored in the storage unit 432.

The display control unit 431a controls display of the operation/display unit 433. The display control unit 431a causes the operation/display unit 433 to display predetermined information based on operation (touch operation, flick operation, or the like) by the user.

The operation/display unit 433 includes, for example, a touch-panel display or the like and has an input function of receiving operation of the occupant of the vehicle 40 by a finger, a pen, or the like and a display function of displaying various information based on control of the display control unit 431a. The operation/display unit 433 displays, for example, information indicating that the terminal 50 has been connected to the vehicle 40, the information indicating that the vehicle 40 has arrived at the entrance gate 31 or the exit gate 32, a checkout complete screen indicating that the checkout of the parking fee has been completed, etc. based on control by the display control unit 431a.

Note that the control unit 431 identifies the user boarding the vehicle 40 by acquiring the information, which indicates the fact that the terminal 50 has been connected to the vehicle 40, (hereinafter, referred to as “connection information”) from a vehicle link unit 512. Note that, a method of identifying the user boarding the vehicle 40 is not particularly limited, and, for example, biometric authentication (for example, fingerprint authentication, voice authentication, iris authentication, face authentication, etc.) or the like may be used.

The positioning unit 434 receives radio waves from a Global Positioning System (GPS) satellite and detects information about the current position of the vehicle 40 (hereinafter, referred to as “vehicle position information”). A method of detecting the vehicle position information is not limited to the method using the GPS satellite, but, for example, a method combining a Light Detection and Ranging, Laser Imaging Detection and Ranging (LiDAR) with a three-dimensional digital map may be used. The positioning unit 434 outputs the detected vehicle position information to, for example, the parking server 20.

Terminal

The terminal 50 is a portable terminal owned by the user boarding the vehicle 40. The user can carry out, for example, deposit of the electronic money (hereinafter, referred to as “charge”), payment using the electronic money, payment by another payment means (for example, credit card) previously registered, etc. through a wallet program installed in the terminal 50. The terminal 50 is realized, for example, by a smartphone, a portable phone, a tablet terminal, a wearable computer, or the like owned by the user.

As illustrated in FIG. 2, the terminal 50 is provided with a control unit 51, a communication unit 52, a storage unit 53, and an operation/display unit 54. Specific configurations of the control unit 51, the communication unit 52, the storage unit 53, and the operation/display unit 54 are similar to those of the control unit 11, the communication unit 12, and the storage unit 13 of the management server 10 and the operation/display unit 433 of the in-vehicle device 43. The control unit 51 functions as the display control unit 511, the vehicle link unit 512, and a payment processing unit 513 through execution of a program stored in the storage unit 53.

The display control unit 511 controls display contents of the operation/display unit 54. The display control unit 511 controls display of the operation/display unit 433. The display control unit 511 causes the operation/display unit 433 to display predetermined information based on operation (touch operation, flick operation, or the like) by the user.

When the user who has the terminal 50 boards the vehicle 40, the vehicle link unit 512 connects the terminal 50 and the vehicle 40 by using the communication functions such as WiFi (registered trademark), BLE, or the like mounted in the vehicle 40 and the terminal 50.

When the user shops at the affiliated shop of the parking, the payment processing unit 513 outputs the payment information thereof to the management server 10. This payment information may be directly output from the terminal 50 to the management server 10 or may be output via another server.

Examples of the case in which the payment information is output to the management server 10 via the other server include a case in which the user makes payment by using the electronic money changed in the wallet. In such a case, the payment processing unit 513 outputs a payment request to the management server 10 via a server (shop server) provided at the shop. Subsequently, the control unit 11 of the management server 10, which has acquired the payment request, reduces the balance of the electronic money in the wallet of the user based on the payment amount included in the payment request and updates the wallet information 132 and the payment history information 133, thereby completing payment.

If an additional parking fee is required, in other words, if additional fee information is acquired from the management server 10, the payment processing unit 513 automatically checks out the additional parking fee by using the wallet service and outputs the information indicating a fact that the checkout has been finished (hereinafter, “checkout finish information”) to the parking server 20. In response to this, the gate control unit 213 of the parking server 20 opens the exit gate 32 and permits exit from the parking.

The operation/display unit 54 displays a payment complete screen indicating a fact that the payment has been completed, a checkout complete screen indicating a fact that the checkout of the parking fee has been completed, information indicating the remaining time that allows free parking for the vehicle 40, information indicating the remaining amount of the payment amount required to make the parking fee free, or the like based on control by the display control unit 511.

Parking Management Method

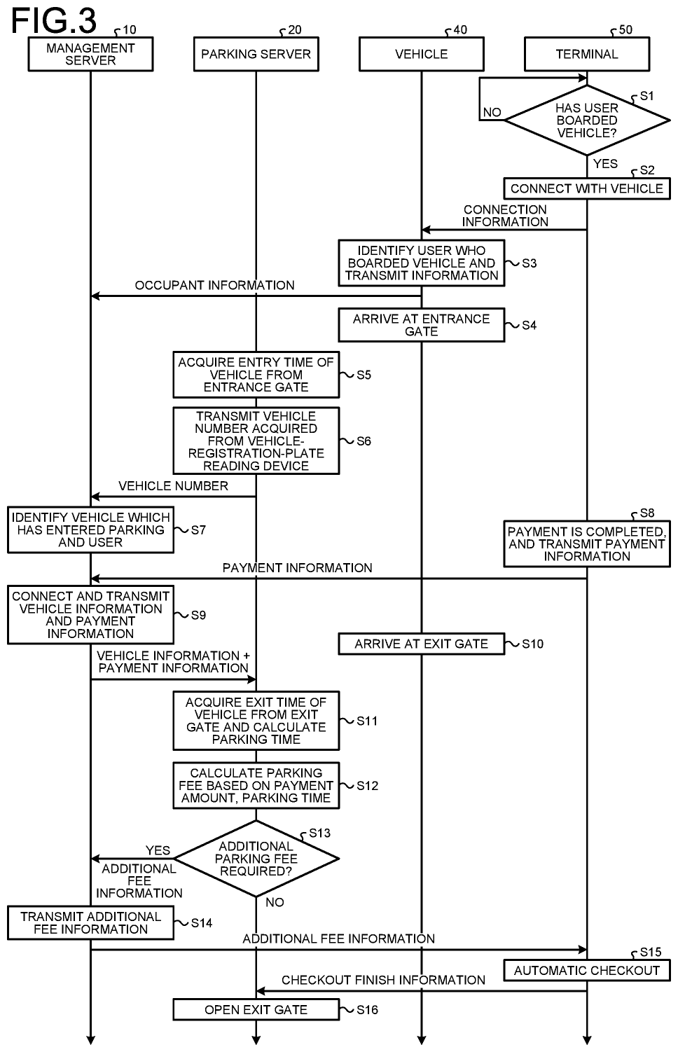

Examples of a processing procedure of a parking management method executed by the parking management system 1 according to the embodiment will be described with reference to FIG. 3 to FIG. 5. Hereinafter, a plurality of embodiments of the parking management method will be described.

### First Embodiment

In the present embodiment, an example of the case in which the vehicle 40, which has entered the parking, is identified by the vehicle number read by the vehicle-registration-plate reading device 33 will be described with reference to FIG. 3.

First, the vehicle link unit 512 of the terminal 50 determines whether the user has boarded the vehicle 40 or not (step S1). If it is determined that the user has boarded the vehicle 40 (Yes in step S1), the vehicle link unit 512 uses the communication function such as WiFi (registered trademark), BLE, or the like to connect the terminal 50 and the vehicle 40 (step S2). On the other hand, if it is determined that the user is not boarding the vehicle 40 (No in step S1), the vehicle link unit 512 returns to step S1.

Subsequently, the control unit 431 of the vehicle 40 identifies the user who has boarded the vehicle 40 and transmits the occupant information to the management server (step S3). Subsequently, when the vehicle 40 arrives at the entrance gate 31 (step S4), the control unit 21 of the parking server 20 acquires the entry time of the vehicle 40 from the entrance gate 31 (step S5). Subsequently, the control unit 21 transmits the vehicle number, which has been acquired from the vehicle-registration-plate reading device 33, to the management server 10 (step S6).

Subsequently, the user identifying unit 111 of the management server 10 identifies the vehicle 40, which has entered the parking, and the user boarding the vehicle 40 based on the occupant information and the vehicle number (step S7). Note that the user identifying unit 111 may identify the user without acquiring the occupant information from the vehicle 40. In such a case, the user identifying unit 111 identifies the vehicle 40, which has entered the parking, and the user boarding the vehicle 40 based on the occupant information of the vehicle 40 previously retained and the vehicle information acquired from the parking server 20.

Subsequently, when the payment by the user is completed, the payment processing unit 513 transmits the payment information to the management server 10 (step S8). Subsequently, the information transfer unit 112 connects the vehicle information (vehicle number) with the payment information and transmits the vehicle information and the payment information to the parking server 20 (step S9).

Subsequently, when the vehicle 40 arrives at the exit gate 32 (step S10), the parking-time calculation unit 211 acquires the exit time of the vehicle 40 from the exit gate 32 and subtracts the entry time from the exit time, thereby calculating the parking time of the vehicle 40 (step S11). Subsequently, the parking-fee calculation unit 212 calculates the parking fee of the vehicle 40 based on the payment amount included in the payment information acquired from the terminal 50, the parking time of the vehicle 40, and the agreement on the parking fee (step S12).

Subsequently, the parking-time calculation unit 211 determines whether an additional parking fee is required or not (step S13). If it is determined that the additional parking fee is required (Yes in step S13), the parking-time calculation unit 211 transmits the additional fee information to the management server 10 (step S14). On the other hand, if it is determined that the additional parking fee is not required (No in step S13), the parking-time calculation unit 211 proceeds to step S16.

Subsequently, the information transfer unit 112 transmits the additional fee information to the terminal 50 (step S14). Subsequently, the payment processing unit 513 of the terminal 50 automatically checks out the additional parking fee by using the wallet service and transmits the checkout finish information to the parking server 20 (step S15). Subsequently, the gate control unit 213 opens the exit gate 32 (step S16).

In this manner, the vehicle number read by the vehicle-registration-plate reading device 33 and the payment information of the user are connected and transmitted to the parking server 20 so that the parking fee can be cancelled out by the payment fee of the user. As a result, ticketless payment of the parking fee can be made without using a parking ticket.

### Modification Example of First Embodiment

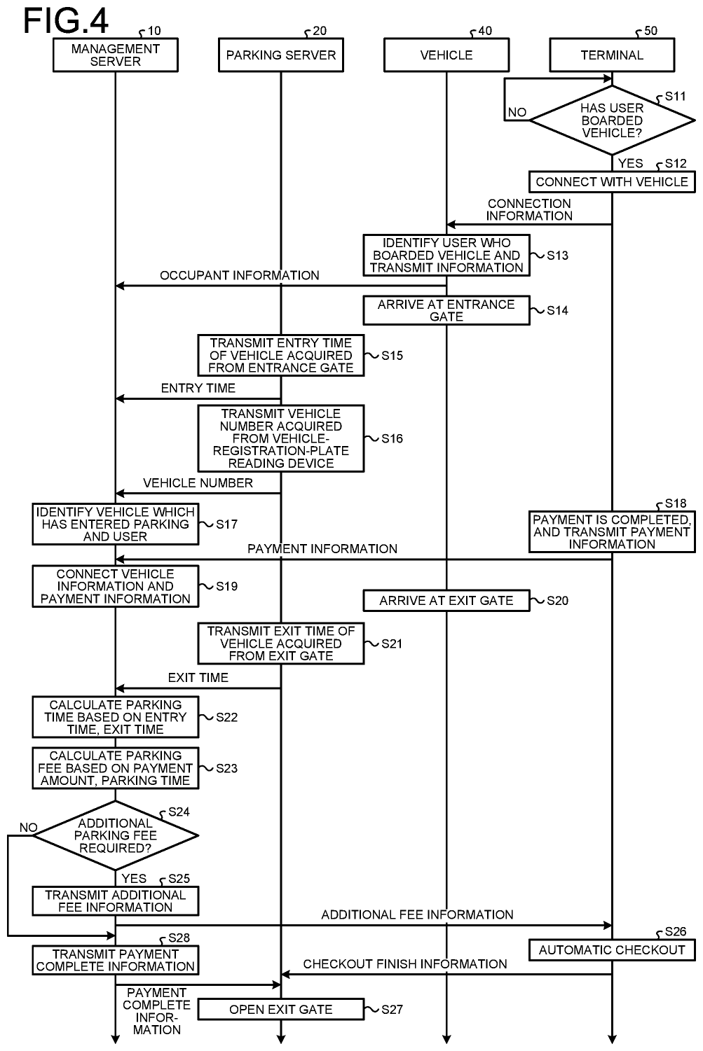

In the present embodiment, an example of the case in which the vehicle 40, which has entered the parking, is identified by the vehicle number read by the vehicle-registration-plate reading device 33 and the case in which the parking time and the parking fee of the vehicle 40 is calculated in the management server 10 side will be described with reference to FIG. 4. Note that, since the processing of steps S11 to S14, S16 to S20, S26, and S27 in this drawing are the same as the processing of steps S1 to S4, S6 to S10, S15, and S16 of FIG. 3, description thereof will be omitted.

In step S15, the control unit 21 of the parking server 20 transmits the entry time of the vehicle 40, which has been acquired from the entrance gate 31, to the management server 10 (step S15). Also, in step S21, the control unit 21 transmits the exit time of the vehicle 40, which has been acquired from the exit gate 32, to the management server 10 (step S21).

Subsequently, the control unit 11 of the management server 10 calculates the parking time of the vehicle 40 by subtracting the entry time from the exit time of the vehicle 40 (step S22). Subsequently, the control unit 11 calculates the parking fee of the vehicle 40 based on the payment amount included in the payment information acquired from the terminal 50, the parking time of the vehicle 40, and the agreement on the parking fee (step S23).

Subsequently, the control unit 11 determines whether the additional parking fee is required or not (step S24). If it is determined that the additional parking fee is required (Yes in step S24), the control unit 11 transmits the additional fee information to the terminal 50 (step S25). On the other hand, if it is determined that the additional parking fee is not required (No in step S24), the parking-time calculation unit 211 transmits payment complete information to the parking server 20 (step S28), and the process proceeds to step S27.

The parking time and the parking fee of the vehicle 40 is calculated in the management server 10 side in this manner. As a result, the computation load on the parking server 20 can be reduced.

### Second Embodiment

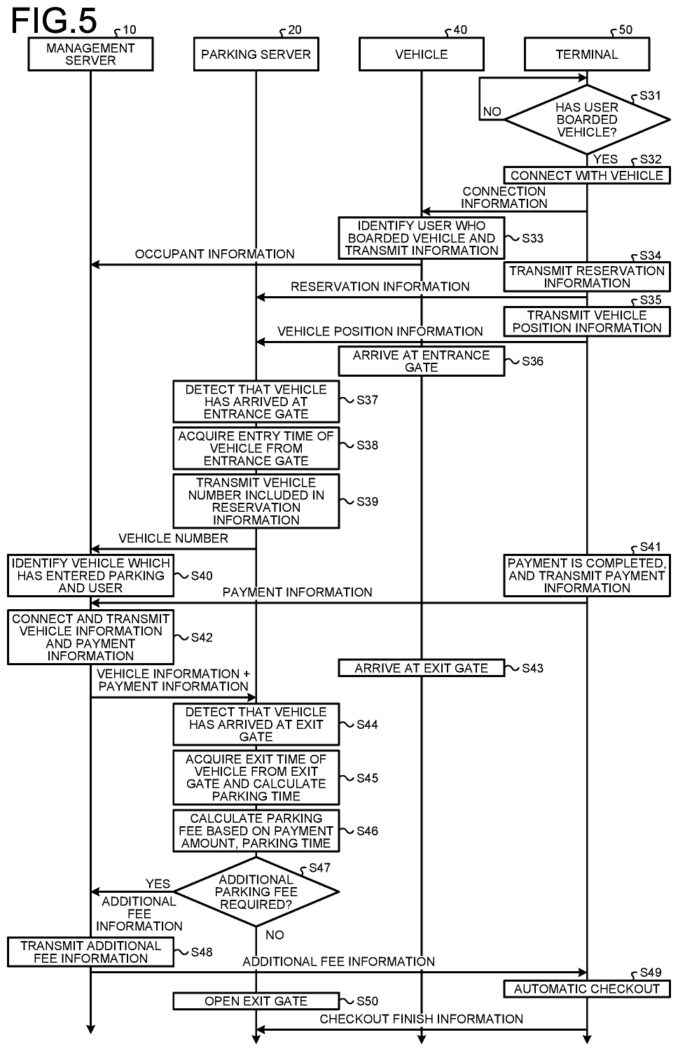

In the present embodiment, the case in which the vehicle 40, which has entered the parking, is identified by reservation information of the parking and vehicle position information will be described with reference to FIG. 5. Note that, since the processing of steps S31 to S33 and S45 to S50 in this drawing is the same as the processing of steps S1 to S3 and S11 to S16 of FIG. 3, description thereof will be omitted.

In step S34, the control unit 51 of the terminal 50 transmits the reservation information of the parking, which has been input by the user through a parking reservation program installed in the terminal 50, to the parking server (step S34). This “reservation information” includes the information for identifying the vehicle 40 (for example, vehicle number, etc.) and the information for identifying the parking (for example, parking name, parking position, parking reservation time, etc.).

Subsequently, the control unit 431 of the vehicle 40 transmits the vehicle position information to the parking server 20 (step S35). In step S35, the control unit 431 transmits the vehicle position information to the parking server 20 at each timing which is preset. Subsequently, when the vehicle 40 arrives at the entrance gate 31 (step S36), the control unit 21 of the parking server 20 detects the fact that the vehicle 40 has arrived at the entrance gate 31 based on the vehicle position information (step S37) and acquires the entry time of the vehicle 40 (step S38). Subsequently, the control unit 21 transmits the vehicle number, which is included in the reservation information, to the management server 10 (step S39).

Subsequently, the user identifying unit 111 of the management server 10 identifies the vehicle 40, which has entered the parking, and the user boarding the vehicle 40 based on the occupant information and the vehicle number (step S40). Note that the user identifying unit 111 may identify the user without acquiring the occupant information from the vehicle 40. In such a case, the user identifying unit 111 identifies the vehicle 40, which has entered the parking, and the user boarding the vehicle 40 based on the occupant information of the vehicle 40 previously retained and the vehicle information acquired from the parking server 20.

Subsequently, when the payment by the user is completed, the payment processing unit 513 transmits the payment information to the management server 10 (step S41). Subsequently, the information transfer unit 112 connects the vehicle information (vehicle number) with the payment information and transmits the vehicle information and the payment information to the parking server 20 (step S42).

Subsequently, when the vehicle 40 arrives at the exit gate 32 (step S43), the parking-time calculation unit 211 of the control unit 21 detects the fact that the vehicle 40 has arrived at the exit gate 32 based on the vehicle position information (step S44). Subsequently, processing of step S45 and thereafter is carried out.

In this manner, the vehicle 40 which has entered the parking is identified based on the reservation information of the parking made by the user and the vehicle position information. As a result, even in the parking which is not provided with the vehicle-registration-plate reading device 33, ticketless payment of the parking fee can be made without using a parking ticket.

As described above, according to the parking management system 1, the parking management device, and the parking management program according to the embodiments, automatic payment of the parking fee can be made in coordination with the payment by the terminal 50 owned by the user. By virtue of this, parking tickets are not required to be taken out and retracted every time at the entrance gate 31 and the exit gate 32 of the parking, and the parking can be used without a ticket. Therefore, entry/exit of the vehicles at the parking can be smoothly carried out.

According to the present disclosure, since parking tickets are not required to be taken out and retracted every time at a gate of parking, entry/exit of vehicles at the parking can be smoothly carried out.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A parking management system comprising:
a management server including a first processor that comprises hardware; and
a parking server including a second processor that comprises hardware,
the first processor being configured to
acquire information of a vehicle that has entered a parking area from the parking server,
identify the vehicle that has entered the parking area and a user boarding the vehicle based on the information of the vehicle, and
if payment information of the user is acquired from a terminal of the user, connect the information of the vehicle and the payment information of the user and output the information of the vehicle and the payment information of the user to the parking server,
the second processor being configured to
calculate a parking fee of the vehicle based on parking time of the vehicle, a payment amount included in the payment information, and a parking fee agreement that is preset, and
if payment of the parking fee has been completed by the terminal, open an exit gate provided in the parking area.

2. The parking management system according to claim 1, wherein
the first processor is configured to
acquire, from the vehicle, information of the user boarding the vehicle, and
identify the vehicle that has entered the parking area and the user boarding the vehicle based on the information of the user and the information of the vehicle.

3. The parking management system according to claim 1, wherein
the information of the vehicle is a vehicle number of the vehicle.

4. The parking management system according to claim 1, wherein
the second processor is configured to
previously acquire, from the terminal, reservation information of the parking area,
acquire position information of the vehicle from the vehicle, and
detect whether the vehicle has entered the parking area or not based on the position information of the vehicle, and
when the second processor detects a fact that the vehicle has entered the parking area, the first processor is configured to acquire, from the parking server, a vehicle number of the vehicle as the information of the vehicle, the vehicle number of the vehicle being included in the reservation information of the parking.

5. The parking management system according to claim 1, wherein
the second processor is configured to
calculate remaining time that allows free parking for the vehicle based on entry time of the vehicle to the parking area and the parking fee agreement, and
output information about the remaining time to the terminal.

6. The parking management system according to claim 1, wherein
the second processor is configured to
calculate a remaining amount of the payment amount required to make the parking fee free based on the parking time of the vehicle, the payment amount included in the payment information, and the parking fee agreement, and
output information about the remaining amount to the terminal.

7. A parking management system comprising:
a management server including a first processor that comprises hardware,
the first processor being configured to
acquire information of a vehicle that has entered a parking area from the parking server provided at the parking area,
identify the vehicle that has entered the parking area and a user boarding the vehicle based on the information of the vehicle,
if payment information of the user is acquired from a terminal of the user, connect the information of the vehicle and the payment information of the user, and
calculate a parking fee of the vehicle based on parking time of the vehicle, a payment amount included in the payment information, and a parking fee agreement that is preset, and
if payment of the parking fee has been completed by the terminal, open an exit gate provided in the parking area.

8. A parking management device comprising:
a processor comprising hardware, the processor being configured to
acquire information of a vehicle that has entered a parking area from the parking server provided at the parking area,
identify the vehicle that has entered the parking area and a user boarding the vehicle based on the information of the vehicle, and
if payment information of the user is acquired from a terminal of the user, connect the information of the vehicle and the payment information of the user and output the information of the vehicle and the payment information of the user to the parking server to calculate a parking fee of the vehicle based on parking time of the vehicle, a payment amount included in the payment information, and a parking fee agreement that is preset.

9. A parking management device comprising:
a processor comprising hardware, the processor being configured to
acquire information of a vehicle that has entered a parking area from the parking server provided at the parking area,
identify the vehicle that has entered the parking area and a user boarding the vehicle based on the information of the vehicle,
if payment information of the user is acquired from a terminal owned by the user, connect the information of the vehicle and the payment information of the user, and
calculate a parking fee of the vehicle based on parking time of the vehicle, a payment amount included in the payment information, and a parking fee agreement that is preset.

10. The parking management device according to claim 8, wherein
the processor is configured to
acquire, from the vehicle, information of the user boarding the vehicle, and
identify the vehicle that has entered the parking area and the user boarding the vehicle based on the information of the user and the information of the vehicle.

11. The parking management device according to claim 8, wherein
the information of the vehicle is a vehicle number of the vehicle.

12. The parking management device according to claim 8, wherein,
when the parking server detects a fact that the vehicle has entered the parking area based on position information of the vehicle, the processor is configured to acquire, from the parking server, a vehicle number of the vehicle as the information of the vehicle, the vehicle number of the vehicle being included in reservation information of the parking previously transmitted from the terminal to the parking server.

13. A non-transitory computer-readable recording medium with an executable program stored thereon, the program being a parking management program configured to cause a processor comprising hardware to execute:
acquiring information of a vehicle that has entered a parking area from the parking server provided at the parking area;
identifying the vehicle that has entered the parking area and a user boarding the vehicle based on the information of the vehicle; and
if payment information of the user is acquired from a terminal of the user, connecting the information of the vehicle and the payment information of the user and outputting the information of the vehicle and the payment information of the user to the parking server to calculate a parking fee of the vehicle based on parking time of the vehicle, a payment amount included in the payment information, and a parking fee agreement that is preset.

14. A non-transitory computer-readable recording medium with an executable program stored thereon, the program being a parking management program configured to cause a processor having hardware to execute:
acquiring information of a vehicle that has entered a parking area from the parking server provided at the parking area;
identifying the vehicle that has entered the parking area and a user boarding the vehicle based on the information of the vehicle;
if payment information of the user is acquired from a terminal of the user, connecting the information of the vehicle and the payment information of the user, and
calculating a parking fee of the vehicle based on parking time of the vehicle, a payment amount included in the payment information, and a parking fee agreement that is preset.

15. The recording medium according to claim 13, wherein the program is further configured to cause the processor to execute
acquiring, from the vehicle, information of the user boarding the vehicle, and
identifying the vehicle that has entered the parking area and the user boarding the vehicle based on the information of the user and the information of the vehicle.

16. The recording medium according to claim 13, wherein
the information of the vehicle is a vehicle number of the vehicle.

17. The recording medium according to claim 13, wherein the program is further configured to cause the processor to execute
when the parking server detects a fact that the vehicle has entered the parking are based on position information of the vehicle, acquiring, from the parking server, a vehicle number of the vehicle as the information of the vehicle, the vehicle number of the vehicle being included in reservation information of the parking previously transmitted from the terminal to the parking server.
